(19) United States
(12) Patent Application Publication
(10) Pub. No.: US 2002/0149456 A1
(43) Pub. Date: Oct. 17, 2002

(54) Actuator, in particular for valves, relays or similar

(76) Inventors: Erwin Krimmer, Pluederhausen (DE); Wolfgang Schulz, Bietigheim-Bissingen (DE); Matthias Brendle, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/049,940

(22) PCT Filed: Jun. 19, 2001
(86) PCT No.: PCT/DE01/02222

(30) Foreign Application Priority Data
Jun. 21, 2000 (DE) 100 29 436.7
Oct. 17, 2000 (DE) 100 51 310.7

(51) Int. Cl. H01F 7/08

(52) U.S. Cl. 335/220

(57) ABSTRACT

An actuator, in particular for valves, relays, or the like, is disclosed, which has an electromagnet (10) with a magnet coil (11), a magnet armature (12) that can be slid between two end positions, and a magnet yoke (13), and has an actuation tappet (14) driven by the magnet armature (12). In order to produce a bistable actuator with a low power consumption and a low heating of current-carrying components—particularly when long switching times in both switch positions are required, on the one hand, the electromagnet (10) is embodied so that its magnet armature (12) has a stable middle position that is disposed between its two end positions, which are determined by the two switch positions of the actuator, and that can be approached from both end positions by supplying current to the magnet coil (11), and on the other hand, a bistable mechanical locking mechanism (15) is provided, which acts on the magnet armature (12) or on the actuation tappet (14) and comes into play in the end positions of the magnet armature (12) (FIG. 1).

### PRIOR ART

The invention is based on an actuator, in particular for valves, relays, or the like, as generically defined by the preamble to claim 1.

Electromagnetic actuators are generally embodied in a monostable manner, i.e. the magnet armature of the actuator—when not supplied with energy—has a stable, definite end position, the so-called neutral position. This end position is usually set by the spring force of a restoring spring, whereas the transfer into its other end position, the so-called switched position, is achieved by supplying power to the magnet coil or the excitation winding of the electromagnet of the magnet armature. In order to hold the magnet armature in the switched position, the magnet coil must be continuously supplied with current, without producing mechanical work in so doing. The result is energy loss and a heating of the actuator and the supply lines to the switch transistors for controlling the magnet coil.

### ADVANTAGES OF THE INVENTION

The actuator according to the invention, with the features of claim 1, has the advantage that it is bistable and the magnet armature always remains in one of the two end positions until it is transferred into the other end position through a temporary supply of current to the magnet coil and then remains there without being supplied with energy from the outside. Energy is only required to transfer the magnet armature into one of the two end positions and the energy is largely converted into mechanical work. The magnet armature is held in the end position itself by means of the mechanical locking device, which is preferably embodied as a snap switch mechanism or as a detent locking mechanism, without the supply of energy so that the power loss and the heating of the actuator and control unit are eliminated. The control unit driver stages for supplying current to the magnet coil therefore does not have to be designed for continuous operation, but only for the short power supply pulses that are used to transfer the magnet armature from the one end position to the other. This cuts down on the installation space occupied and the costs incurred by the components in the electrical circuit.

The bistable electromagnetic actuator according to the invention is particularly well-suited for electromagnetically actuated pneumatic and hydraulic intermediary valves as well as for bistable relays, particularly if very long switching times are required in the two switch positions corresponding to the end positions of the magnet armature and/or if the switch positions should be maintained even in the event of a failure in the voltage supply to the electromagnet.

Advantageous modifications and improvements of the actuator disclosed in claim 1 are possible by means of the measures taken in the remaining claims.

According to a preferred embodiment of the invention, the stable middle position of the magnet armature disposed between the two end positions, which is also referred to as the equilibrium position of the electromagnet, is realized in such a way that the magnet armature, passes through two mutually aligned openings in the magnet yoke with its two armature ends and that the length of the magnet armature and the embodiment of the magnet yoke are matched to each other so that in each end position of the magnet armature, one of the armature ends is inserted maximally into the magnet yoke and the other is inserted minimally into the magnet yoke. The gradient of the magnetic flux or of the permeability, which is decisive to the magnetic force, has a particularly large axial component on the minimally inserted armature end and has only a radial component on the maximally inserted armature end so that the magnet armature is pulled into the magnet yoke with its inserted end and is fixed in this end position by the mechanical locking device.

According to a preferred embodiment of the invention, the fixing device is embodied as a snap switch mechanism, where low-friction snap switch mechanisms are particularly suitable for assuring a reproducible switching behavior of the actuator, which is of particular significance for optimizing the pulse length and pulse height of the power supply pulses. Low-friction snap switch mechanisms include, for example, tilt snap switch mechanisms with knife-edge bearings.

According to an advantageous embodiment of the invention, the power is supplied to the magnet coil by means of current pulses whose duration is determined so that with the end of a current pulse, the magnet armature being moved out of its end position has approximately reached its middle position and the energy stored in the magnet armature is sufficient to drive the magnet armature past the middle position and into its other end position. Therefore, the electromagnet is always supplied with current only until it reaches its equilibrium position and the equilibrium position is passed with the aid of the kinetic energy stored in the magnet armature. In the event that the locking device is embodied as a snap switch mechanism, after the equilibrium position is passed, the energy stored in the snap switch mechanism is also available for moving the magnet armature into its end position.

If a guide element or a second locking device is provided, then a guiding of the magnet armature by means of the coil body can be advantageously eliminated, which reduces the distance between the magnet armature and the coil.

### DRAWINGS

The invention will be explained in detail below in conjunction with exemplary embodiments shown in the drawings.

FIG. 1 shows a longitudinal section through an electromagnetic actuator, schematically depicted,

FIGS. 2 to 4 respectively show details of a longitudinal section through the actuator in three different slide positions of the magnet armature, schematically depicted,

FIG. 5 shows a characteristic curve of the actuator in FIG. 1,

FIG. 6 shows a detail of a longitudinal section through an electromagnetic actuator according to a second exemplary embodiment,

FIG. 7 shows another exemplary embodiment, and

FIG. 8 shows a spring for an actuator according to the invention.

### DESCRIPTION OF THE EXEMPLARY EMBODIMENTS

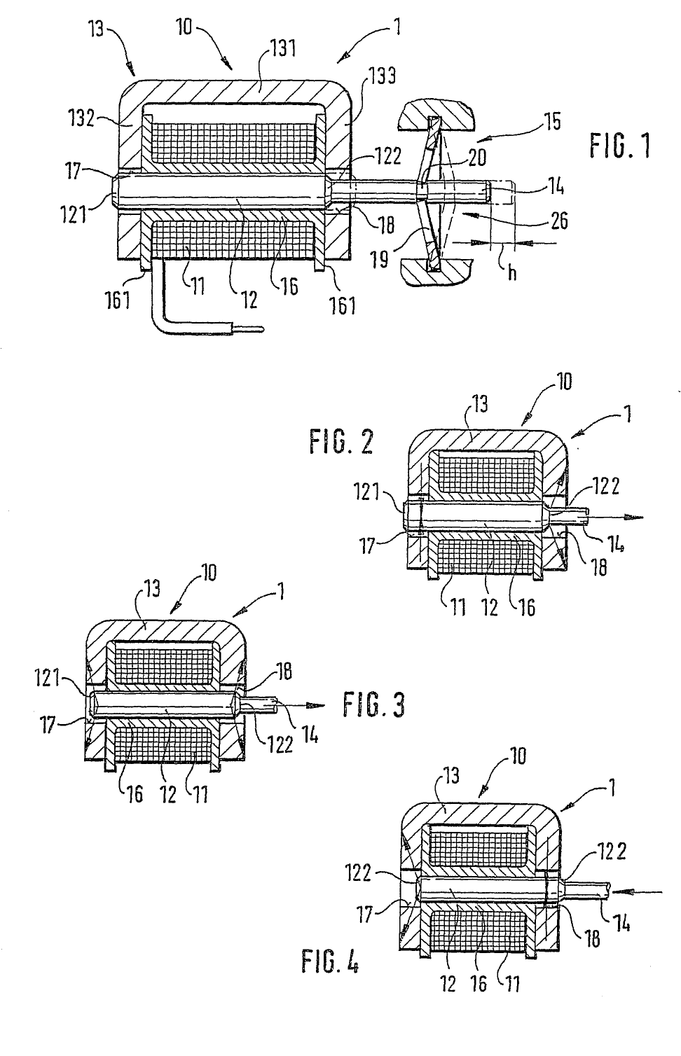

The electromagnetic actuator 1 for pneumatic or hydraulic intermediary valves or for bistable relays, which is shown in a schematic longitudinal section in FIG. 1, has an electromagnet 10 with a magnet coil 11, with a magnet armature 12 that can be slid between two end positions and with a magnet yoke 13 that constitutes the back iron, as well as an actuation tappet 14 affixed to the magnet armature 12, and a bistable mechanical locking device 15, which comes into play in the end positions of the magnet armature 12, acts on the actuating tappet 14, and fixes the actuating tappet 14 with the magnet armature 12 in each of its two end positions.

The magnet coil 11 is wound on a hollow cylindrical coil body 16 similar to a yarn spool, which is bounded on the ends by two annular flanges 161. The magnet yoke 13 is U-shaped and has two yoke legs 132, 133, which extend parallel to each other and are connected to each other by means of a yoke bridge 131. The magnet yoke 13 embraces the coil body 16 with the wound magnet coil 11 between the yoke legs 132, 133 so that the coil axis is aligned with the normals of two insertion openings 17, 18 let into the two yoke legs 132, 133. The magnet armature 12 is guided so that it can move axially inside the hollow cylindrical coil body 16 and is matched to the magnet yoke 13 in length so that in each end position of the magnet armature 12, one of the armature ends 121 or 122 is inserted maximally into one of the insertion openings 17, 18, while the other is inserted minimally into the other insertion opening. The maximal insertion depth of the armature ends 121, 122 is dimensioned as slightly greater than thickness of the yoke legs 132, 133 measured in the axial direction of the magnet armature. In this manner, the magnet armature 12 has a stable middle position, also referred to as the equilibrium position of the electromagnet 10, which is disposed in the middle between the two end positions and can be approached from the two end positions by supplying the magnet coil 11 with current.

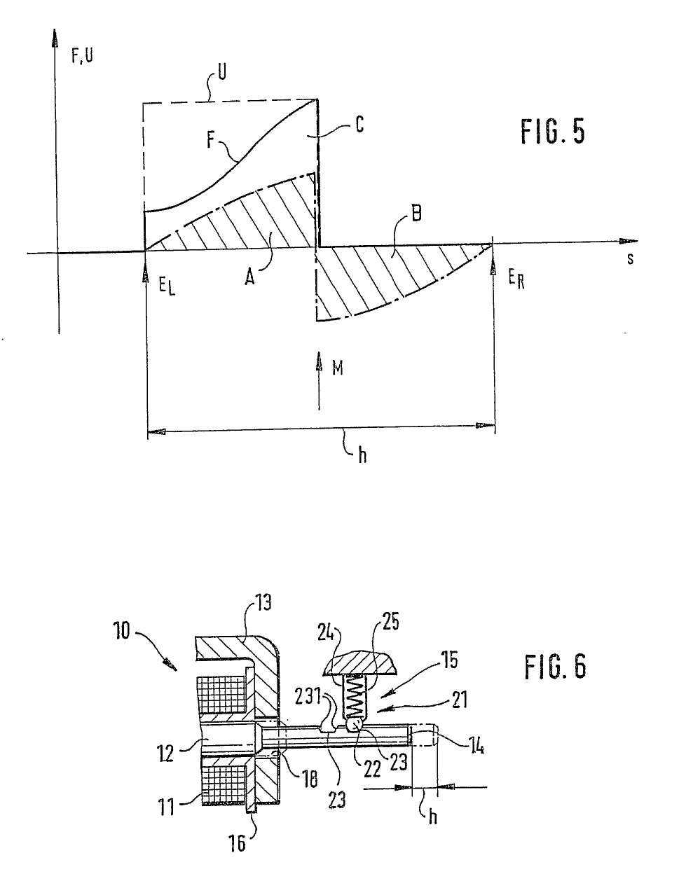

In the depiction in FIG. 2, the magnet armature 12 is inserted with its left armature end 121 maximally into the insertion opening 17 in the magnet yoke 13 and is inserted with its right armature end 122 minimally into the insertion opening 18 in the magnet yoke 13. This end position of the magnet armature 12 is labeled E_{L} in the characteristic curve depicted in FIG. 5. The characteristic curve in FIG. 5 demonstrates on the one hand the function of the magnetic force F over the sliding path s of the magnet armature 12 and on the other hand, demonstrates the function of the voltage pulse applied to the magnet coil 11 over the sliding path of the magnet armature 12. In the above-mentioned stable left end position E_{L} of the magnet armature 11, it is fixed by the locking device 15 without energy being supplied to the magnet coil 11.

If a voltage pulse with an arbitrary polarity is applied to the magnet coil 11, then the gradient of the magnetic flux or of the permeability, which is decisive to the magnetic force acting on the magnet armature 12, has a particularly large axial component at the armature end 122 that is minimally inserted into the insertion opening 18 and has only a radial component at the armature end 12 that is maximally inserted into the insertion opening 17. As a result, a greater portion of magnetic force acts on the magnet armature 12 in the axial direction so that the magnet armature 12 is driven toward its middle position, which is shown in FIG. 3 and in which the two armature ends 121, 122 are inserted the same depth into the insertion openings 17, 18. The magnet armature 12 has reached the middle position labeled M in FIG. 5. The magnetic force F acting on the magnet armature can be inferred from the characteristic curve in FIG. 5. When the middle position M of the magnet armature 12 is reached, the power supply to the magnet coil 11 is switched off. The energy stored in the magnet armature 12 is sufficient to drive it into its right end position E_{R}, in which it is once more fixed by the locking device 15. The magnet armature 12 assumes the position shown in FIG. 4, in which its right armature end 122 is inserted maximally into the insertion opening 18 and its left armature end 121 is inserted minimally into the insertion opening 17. The magnet armature 12 has executed the entire stroke h (in FIGS. 1 and 5).

The locking device 15 for fixing the two end positions of the magnet armature 12 is embodied as a split spring washer 19 in FIG. 1, which represents an exemplary embodiment for a universal bistable snap switch mechanism 26. The spring washer 19 is clamped in place spatially with its outer edge and engages in an axially immobile fashion with its inner edge in an annular groove 20 embodied on the actuation tappet 14. If the magnet armature 12 is transferred from its left end position E_{L} shown in FIG. 1 (also see FIG. 2) into its middle position M shown in FIG. 3, then the spring washer 19 in FIG. 1 is pushed to the right and assumes a largely extended position, its so-called slack point position. If the magnet armature 12 is moved further, past its middle position M, (FIG. 4), then the spring washer 19, as shown with dashed lines in FIG. 1, snaps to the right past its slack point position, exerting drive work on the magnet armature 12 and supporting the movement of the magnet armature into its end position shown in FIG. 4. The characteristic curve of the spring washer 19 over the sliding path s of the magnet armature 12 is depicted with a dot-and-dash line in FIG. 5. Initially, the electromagnet 10 must exert additional force in order to push the spring washer 19 into its extended position. The work exerted by the electromagnet 10 in so doing (depicted in FIG. 5 as a shaded area A) is stored in the spring washer 19 and after the middle position M is passed, is imparted to the magnet armature 12 as drive energy so that the magnet armature 12 is driven into its right end position E_{R}. The drive work exerted by the spring washer 19 is depicted in FIG. 5 by the shaded area B between the middle position M and the right end position E_{R}. The shaded area C disposed above the area A in FIG. 5 is the acceleration work exerted on the magnet armature 12 by the electromagnet 10.

In the modified electromagnetic actuator shown in the detail in FIG. 6, the locking mechanism 15 for currentless fixing of the magnet armature 12 it its two stable end positions is embodied as a detent locking mechanism 21. In an extremely simple fashion, a detent locking mechanism 21 of this kind is comprised of a spring-loaded detent element 22, which engages in a detent recess or detent groove 23 in the actuation tappet 14 in each end position of the magnet armature 12. The two detent grooves 23 are disposed in the actuation tappet 14 spaced apart from each other by an axial distance the corresponds to the stroke h of the magnet armature 12. The detent element 22, which is embodied here as a detent sphere, is guided in a spatially fixed sleeve 24, which is aligned at right angles to the actuation tappet 14 and contains a detent spring 25. The detent spring 25 is supported at one end against the detent sphere or the detent element 22 and is supported at the other end against the sleeve bottom and pushes the detent element 22 into the respective detent groove 23. The two detent grooves 23 have lifting bevels 231 so that when the actuation tappet 14 is slid, the detent element 22 can be lifted out of the detent groove 23.

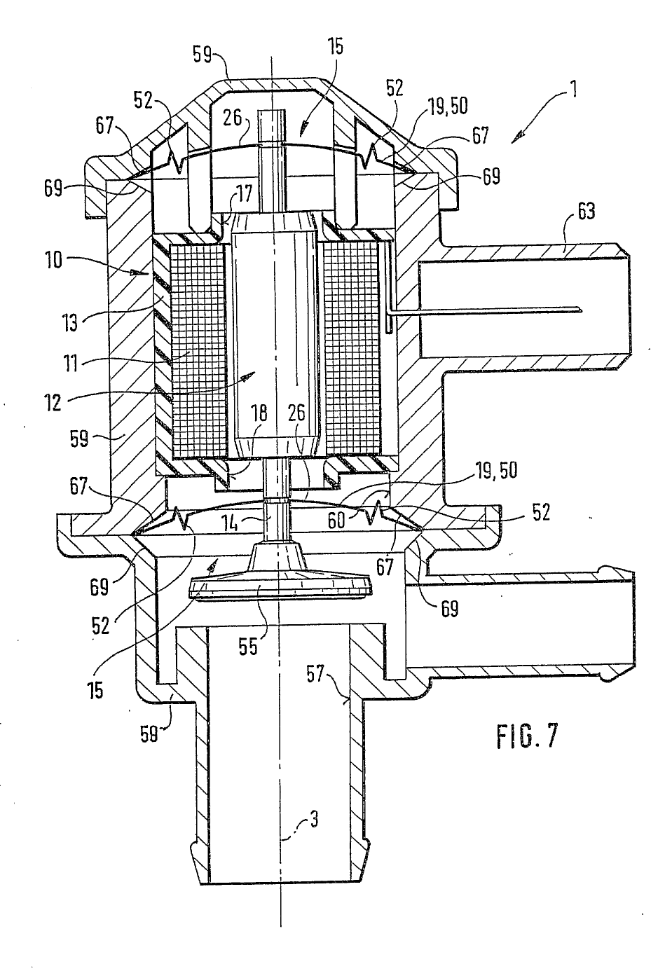

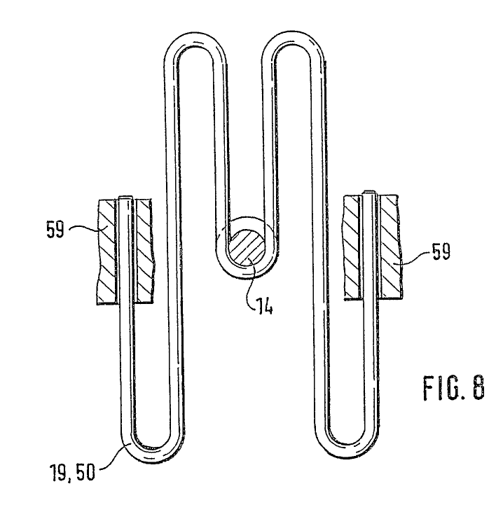

FIG. 7 shows another exemplary embodiment of the actuator 1 with a central axis 3.

In exemplary embodiments according to the preceding figures, the magnet armature 12 is guided by the coil body 16 and/or by the locking mechanism 15.

However, the magnet armature 12 can also be guided by only a guide element 50 and the locking mechanism 15. The guide element 50, however, can also be embodied as an additional locking mechanism 15 in the form of a leaf spring 19.

For example in the longitudinal direction in relation to the central axis 3, the leaf spring 19 has at least one spring element 52 in order to permit a better follow-through past the slack point and in order to prevent the attendant lateral forces of the leaf spring 19.

The actuation tappet 14 has a valve plate 55, which opens or closes an opening 57 of a housing 59. In an end position of the valve plate 55, the opening 57 is open and in the other end position, it is closed. The actuator 1, the housing 59, the valve plate 55, and the opening 57, among others, are part of a valve for a tank ventilation system, for example. The actuator 1 is connected to an external electrical energy supply by means of an electrical connection 63.

On its inner wall 60, the housing 59 has a first stop 67 and a second stop 69, which the at least one leaf spring 19 strikes in its end positions.

FIG. 8 shows the shape of a leaf spring 19, which is comprised of two mirror-inverted S sections connected to each other, where the cross section of the spring material is rectangular or round, for example.

The tappet 14 here moves perpendicular to the plane of the drawing, for example.

The ends of the leaf spring 19 are affixed to the housing 59. As a result, the leaf spring 19 is initially stressed. This occurs, for example, due to the fact that the leaf spring 19 is compressed in the plane of the drawing, between the two anchor points in the housing 59.

1. An actuator, in particular for valves, relays, or the like, with an electromagnet (10), which has a magnet coil (11), a magnet armature (12) that can be slid between two end positions, and a magnet yoke (13), and with an actuation tappet (14) driven by the magnet armature (12), characterized in that the electromagnet (10) is embodied so that its magnet armature (12) has a stable middle position, which is disposed between the two end positions and can be approached from the two end positions by supplying current to the magnet coil (11), and that at least one bistable mechanical locking mechanism (15), which comes into play in the end positions, acts on the magnet armature (12) or on the actuation tappet (14).

2. The actuator according to claim 1, characterized in that the magnet armature (12) is inserted with its two armature ends (121, 122) through mutually aligned insertion openings (17, 18) in the magnet yoke (13) and that the length of the magnet armature (12) and the embodiment of the magnet yoke (13) are matched to each other so that in each end position of the magnet armature (12), one of the armature ends is inserted maximally into the associated insertion opening (17, 18) in the magnet yoke (13) and the other is inserted minimally into the associated insertion opening (17, 18).

3. The actuator according to claim 2, characterized in that the magnet yoke (13) is U-shaped, with two yoke legs (132, 133) connected by means of a yoke bridge (131 ) and that the two insertion openings (17, 18) for the armature ends (121, 122) of the magnet armature (12) are disposed in the opposing yoke legs (132, 133).

4. The actuator according to claim 3, characterized in that the magnet coil (11) is wound onto a hollow cylindrical coil body (16), which is embraced between the yoke legs (132, 133) of the magnet yoke (13) so that the coil axis is aligned with the normals of the insertion openings (17, 18), and in that the magnet armature (12) is guided so that it can move axially in the coil body (16).

5. The actuator according to claim 3 or 4, characterized in that the maximal insertion depth of the armature ends (121, 122) is slightly greater than the width of the yoke legs (132, 133) extending in the axial direction of the magnet armature (12).

6. The actuator according to one of claims 1 to 5, characterized in that the magnet coil (11) is supplied with current by means of current pulses, whose duration is determined so that with the end of one current pulse, the magnet armature (12) being moved out of its end position has approximately reached its middle position and the energy stored in the magnet armature (12) is sufficient to drive the magnet armature (12) past the middle position, into its other end position.

7. The actuator according to one of claims 1 to 6, characterized in that the locking mechanism (15) is embodied as a detent locking mechanism (21).

8. The actuator according to one of claims 1 to 6, characterized in that the locking mechanism (15) is embodied as a snap switch mechanism (26), which after a slack point position is passed, exerts a drive-force on the magnet armature (12) or actuation tappet (14).

9. The actuator according to claim 8, characterized in that the snap switch mechanism is embodied as a split spring washer (19).

10. The actuator according to claim 1, characterized in that two locking mechanisms (15) are provided.

11. The actuator according to claim 1 or 8, characterized in that there is at least one guide element (50) so that the magnet armature (12) is guided by the at least one guide element (50) and the locking mechanism (15).

12. The actuator according to claim 1, characterized in that the actuator (1) has two locking mechanisms (15) and that the magnet armature (12) is guided by the locking mechanisms (15).

13. The actuator according to claim 1 or 8, characterized in that the actuation tappet (14) has a valve plate (55), which opens or closes an opening (57) in a housing (59).

14. The actuator according to claim 1, characterized in that the actuator (1) is part of a tank ventilation system.

15. The actuator according to one or more of claims 1, 7, 8, or 10 to 12, characterized in that the locking mechanism (15) is a leaf spring (19).

16. The actuator according to claim 15, characterized in that the leaf spring (19) has at least one spring element (52).

17. The actuator according to claim 15, characterized in that the leaf spring (19) is comprised of two mirror-inverted S sections connected to each other.
